(19) United States
(12) Patent Application Publication
(10) Pub. No.: US 2018/0338166 A1
(43) Pub. Date: Nov. 22, 2018

(54) REMOTELY VALIDATING A WEBPAGE VIDEO STREAM

(71) Applicant: SYMANTEC CORPORATION, Mountain View, CA (US)

(72) Inventors: Dan Amiga, Ramat Hasharon (IL); Roee Kasher, Tel Aviv-Yafo (IL); Yoav Horman, Tel Aviv-Yafo (IL); Shuky Chen, Tel Aviv-Yafo (IL)

(21) Appl. No.: 15/985,441

(22) Filed: May 21, 2018

Related U.S. Application Data
(60) Provisional application No. 62/509,250, filed on May 22, 2017.

(51) Int. Cl. H04N 21/235; H04L 29/08; G06F 17/30; H04N 21/647; H04L 29/06

(52) U.S. Cl. CPC H04N 21/2355; H04L 67/025; H04L 63/123; H04N 21/647; G06F 17/3089

(57) ABSTRACT

Remotely validating a webpage video stream. In one embodiment, a method may include a remote isolation server receiving webpage data that includes a reference to a video stream from a webserver, modifying the webpage data to change a source of the video stream in the reference from the webserver to the remote isolation server, sending the modified webpage data to a local browser on a local network device, receiving a first request for the video stream from the local browser, sending a second request for the video stream to the webserver, receiving the video stream from the webserver, performing security validation on the video stream, and sending the validated video stream for display in the local browser in a webpage rendered based on the modified webpage data.

### CROSS-REFERENCE TO A RELATED APPLICATION

This application claims the benefit of, and priority to, U.S. Provisional Application No. 62/509,250, filed May 22, 2017, which is incorporated herein by reference in its entirety.

### BACKGROUND

A webpage is a document written in a standard markup language that is typically downloaded to a local network device over the World Wide Web of the Internet from a webserver. Once downloaded, the webpage is then rendered to a user of the local network device in an application known as a web browser (or simply a “browser”). When a webpage that was downloaded from a webserver is rendered in a browser, the webpage may have sub-resources that are downloaded from other third-party webservers (such as ad network webservers, Content Distribution Network webservers, third party analytics webservers, etc.). Further, webpages may include dynamic content, such as a video stream that is displayed in the webpage. Browsers may be configured to employ many different technologies and programming languages and may also be configured to execute executable content (that is downloaded as part of a webpage or from third-party webservers) during the rendering of the webpage. Allowing a browser to execute executable content, such as executable content that is included in a video stream of a webpage (which may be a default setting in the browser), may add dynamic functionality to the webpage, thus making the webpage more useful to a user.

In the infancy of the Internet and World Wide Web most webpages were simple and included text and perhaps some images. In more recent years, webpage content has come to include more complex elements. A standard webpage may not only include HTML (Hypertext Markup Language), but also may include different Fonts, CSS (Cascading Style Sheets), SVG (Scalable Vector Graphics), scripts or other executable content, different plugins such as Flash, and video and/or audio content.

As webpages have become more complex (and more common in everyday use), they have also become increasingly used by malicious actors to infect (e.g., in the form of malware, ransom-ware, viruses, phishing attacks using malicious links or attachments sent via email, drive by downloads, zero day browser exploits, etc.) computers that are used by end users. The malicious code can be embedded in scripts (e.g., JavaScript, VBScript) of a webpage, plugins (e.g., Java, Flash) that are used by a webpage, or even within the images or video content that is part of a webpage (e.g., by taking advantages of how such content is handled by the local browser).

One potential problem with allowing a browser to execute executable content in video stream of a webpage while displaying the video stream in the webpage is the potential for the executable content to be malicious. For example, a purveyor of a computer virus may embed the virus as malicious executable content in a video stream of a webpage in an attempt to compromise a local network device with the virus. In particular, as the video stream is streamed to, and displayed in, a browser at the local network device and the malicious executable content is executed by the browser during the display of the video stream in the webpage, the virus may compromise the local network device.

Therefore, although it may be useful to a user to allow a browser to execute executable content in a video stream of a webpage while displaying the video stream, the potential for the executable content to be malicious may present a security threat to the local network device on which the browser is executing.

The subject matter claimed herein is not limited to embodiments that solve any disadvantages or that operate only in environments such as those described above. Rather, this background is only provided to illustrate one example technology area where some embodiments described herein may be practiced.

### SUMMARY

In one embodiment, a computer-implemented method for remotely validating a webpage video stream may be performed, at least in part, by a remote isolation server including one or more processors. The method may include (a) receiving, at a remote isolation server, webpage data that includes a reference to a video stream from a webserver, (b) modifying, at the remote isolation server, the webpage data to change a source of the video stream in the reference from the webserver to the remote isolation server, (c) sending, from the remote isolation server, the modified webpage data to a local browser on a local network device, (d) receiving, at the remote isolation server, a first request for the video stream from the local browser, (e) sending, from the remote isolation server, a second request for the video stream to the webserver, (f) receiving, at the remote isolation server, the video stream from the webserver, (g) performing, at the remote isolation server, security validation on the video stream, and (h) sending, from the remote isolation server to the local browser, the validated video stream for display in the local browser in a webpage rendered based on the modified webpage data.

In some embodiments, the method may further include receiving, at the remote isolation server, metadata from the local browser, the metadata comprising one or more of current display time in the video stream, an error indicating that a fallback process should be employed for the video stream, and a user interface events the video stream.

In some embodiments, the reference received at (a) may include a reference to a metadata file that contains video playing instructions for the video stream, and the modifying at (b) may include changing the source of the video stream in the metadata file. In these embodiments, the metadata file may be a video manifest file.

In some embodiments, the modifying at (b) may include modifying the webpage data to change a document object model of the webpage data to substitute an alternative video player for an original video player due to the local browser not supporting the original video player.

In some embodiments, the performing of the security validation at (g) may be performed without rendering the video stream at a remote isolation server. In some embodiments, the performing of the security validation at (g) may include transmuxing the video stream from an original video stream format to an alternative video stream format due to the local browser not supporting the original video stream format. In some embodiments, the performing of the security validation at (g) may include transcoding the video stream to prevent an execution of malicious executable content in the video stream. In some embodiments, the performing of the security validation at (g) may be performed without performing synchronization between video and audio at a remote isolation server.

In some embodiments, the sending at (h) may include sending the validated video stream in a compressed video format.

Also, in some embodiments, one or more non-transitory computer-readable media may include one or more computer-readable instructions that, when executed by one or more processors of a remote isolation server, cause the remote isolation server to perform a method for remotely validating a webpage video stream.

It is to be understood that both the foregoing summary and the following detailed description are explanatory and are not restrictive of the invention as claimed.

### BRIEF DESCRIPTION OF THE DRAWINGS

Embodiments will be described and explained with additional specificity and detail through the use of the accompanying drawings in which:

FIG. 1 illustrates an example system configured for remotely validating a webpage video stream;

FIGS. 2A-2B are a flowchart of an example method for remotely validating a webpage video stream; and

FIG. 3 illustrates an example computer system that may be employed in remotely validating a webpage video stream.

### DETAILED DESCRIPTION

Although allowing a browser to execute executable content that is included in a video stream of a webpage may add dynamic functionality to the webpage, the potential for the executable content to be malicious may present a security threat to the local network device on which the browser is executing. One solution for avoiding this security threat involves sandboxing where executable content is executed in a sandbox in the browser to attempt to prevent any malicious executable content from harming the local network device on which the browser is executing. Unfortunately, however, sandboxing methods generally fail due to difficulties in sandboxing all executable content in a video stream of a webpage and/or difficulties in accurately identifying and sandboxing all executable content in a video stream of a webpage that is malicious.

Some embodiments disclosed herein may enable remotely validating a webpage video stream. In particular, where a webpage includes a video stream, some embodiments may allow a remote isolation server to receive webpage data that includes a reference to a video stream from a webserver and modify the webpage data to change a source of the video stream in the reference from the webserver to the remote isolation server. The remote isolation server may then send the modified webpage to a local browser on a local network device. Then, when the local browser attempts to stream the video stream, the remote isolation server may receive a first request for the video stream from the local browser, send a second request for the video stream to the webserver, and receive the video stream from the webserver. Next, the remote isolation server may perform security validation on the video stream and then send the validated video stream for display in the local browser in a webpage rendered based on the modified webpage data.

In some embodiments, the security validation performed by the remote isolation server may prevent the execution of malicious executable content in the video stream by the local browser. In this manner, a webpage may be rendered at a local network device, and a video stream may be displayed in the webpage without, requiring the local browser to identify and sanitize malicious executable content in the video stream, thus securely preventing any malicious executable content in the video stream of the webpage from being executed during the display of the video stream in the webpage in the browser on the local network device.

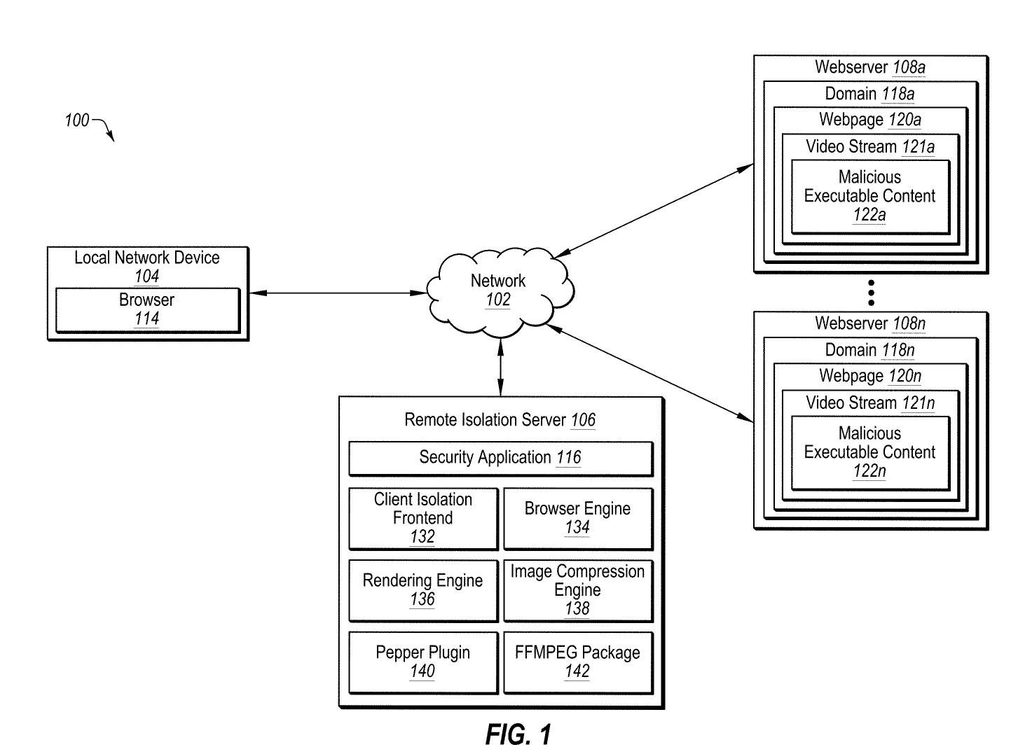

Turning to the figures, FIG. 1 illustrates an example system 100 configured for remotely validating a webpage video stream. The system 100 may include a network 102, a local network device 104, a remote isolation server 106, and webservers 108a-108n.

In some embodiments, the network 102 may be configured to communicatively couple the local network device 104, the remote isolation server 106, and the webservers 108a-108n to one another using one or more network protocols, such as the network protocols available in connection with the World Wide Web. In some embodiments, the network 102 may be any wired or wireless network, or combination of multiple networks, configured to send and receive communications (e.g., via data packets) between systems and devices. In some embodiments, the network 102 may include a Personal Area Network (PAN), a Local Area Network (LAN), a Metropolitan Area Network (MAN), a Wide Area Network (WAN), a Storage Area Network (SAN), the Internet, or some combination thereof. In some embodiments, the network 102 may also be coupled to, or may include, portions of a telecommunications network, including telephone lines, for sending data in a variety of different communication protocols, such as a cellular network or a Voice over IP (VoIP) network.

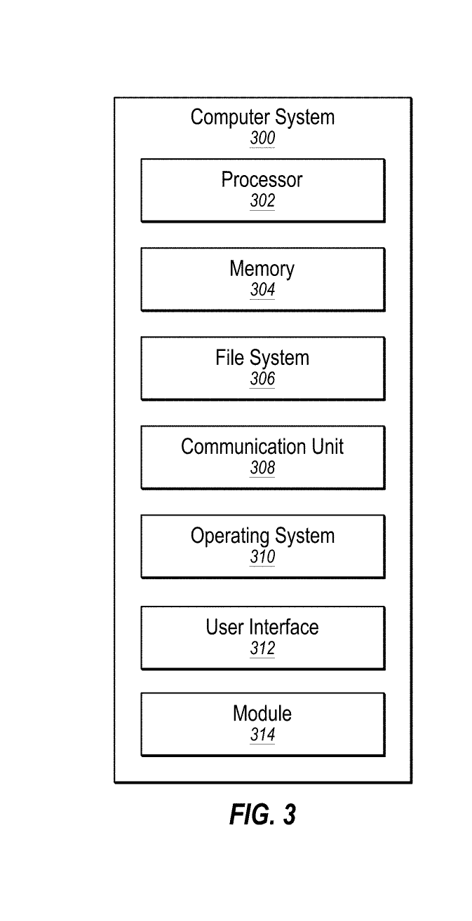

In some embodiments, the webservers 108a-108n may each be any computer system capable of communicating over the network 102 and capable of hosting webpages addressable at a particular web domain, examples of which are disclosed herein in connection with the computer system 300 of FIG. 3. The webservers 108a-108n may be addressable on domains 118a-118n and may host webpages 120a-120n, respectively. The webpages 120a-120n may include video streams 121a-121n that include embedded executable content, such as malicious executable content 122a-122n. Each of the malicious executable content 122a-122n may be, for example, an executable file or executable script in a scripting language such as VBScript, AngularJS, JQuery, Bootstrap, AJAX, JScript, and ActionScript. The malicious functionality of the malicious executable content may include, for example, functionality typical of a spyware, a virus, a worm, a logic bomb, a trapdoor, a Trojan horse, a Remote Admin Trojan (RAT), a malware, a mobile malicious code, a malicious font, and a rootkit, or some combination thereof.

In some embodiments, the local network device 104 may be any computer system capable of communicating over the network 102 and executing a browser, examples of which are disclosed herein in connection with the computer system 300 of FIG. 3. The local network device 104 may include a browser 114. The browser 114 may be configured to render webpages, such as the webpages 120a-120n, to a user of the local network device 104. The browser 114 may be further configured to display video streams in webpages, such as the video streams 121a-121n, to a user of the local network device 104. In some embodiments, the browser 114 may be a standard off-the-shelf web browser such as, but not limited to, Google Chrome, Mozilla Firefox, Safari, Internet Explorer, Microsoft Edge.

In some embodiments, the remote isolation server 106 may be any computer system, or combination of multiple computer systems, capable of communicating over the network 102 and capable of monitoring the local network device 104 in order to protect the local network device 104 from malicious executable content, examples of which are disclosed herein in connection with the computer system 300 of FIG. 3.

In a traditional environment, a local network device such as the local network device 104 may make requests for webpages to the webservers 108a-108n and responses (e.g., in the form of webpage content) may be delivered directly to the local network device 104. In contrast, however, in some embodiments disclosed herein requests from the local network device 104 are routed through the remote isolation server 106, which functions as an intermediary computer system (perhaps without the knowledge of the end user), and the remote isolation server 106 transmits webpage requests to the webservers 108a-108n. The webpage content of the webpages 120a-120n that is provided by the webservers 108a-108n is then routed back through the requesting remote isolation server 106. This type of implementation may decrease (or eliminate altogether) vulnerabilities that may be present in the webpages 120a-120n and/or the browser 114 that is designed to view such webpages.

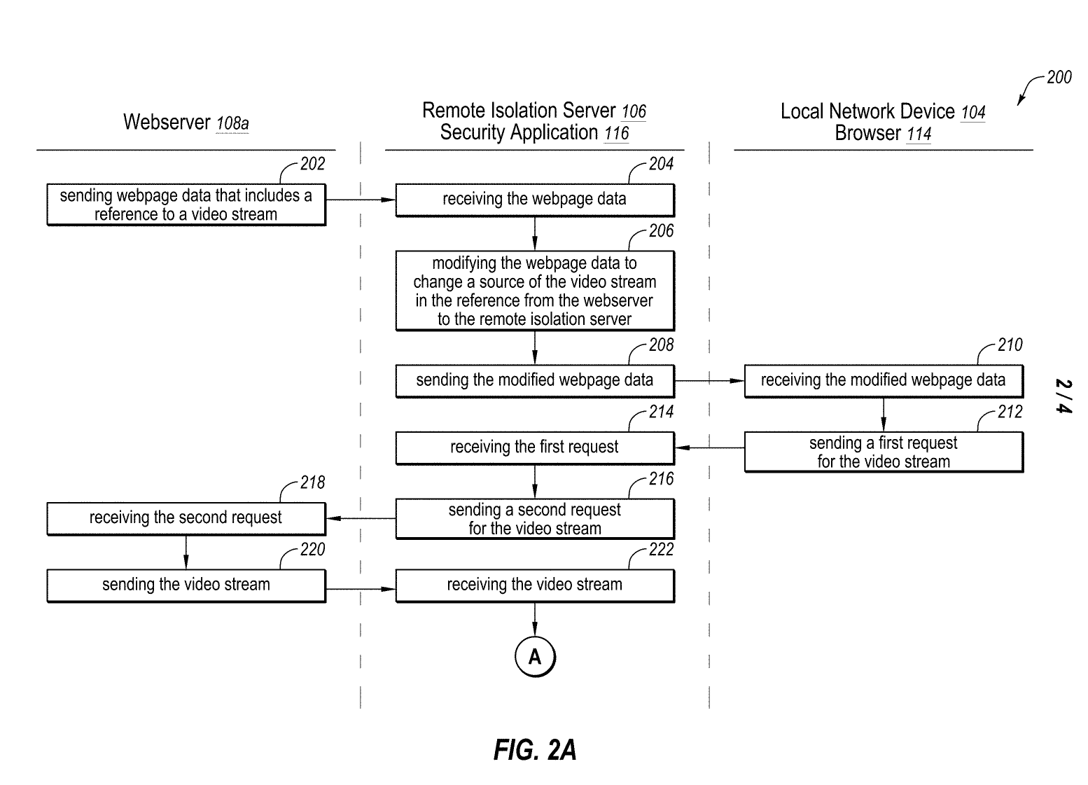

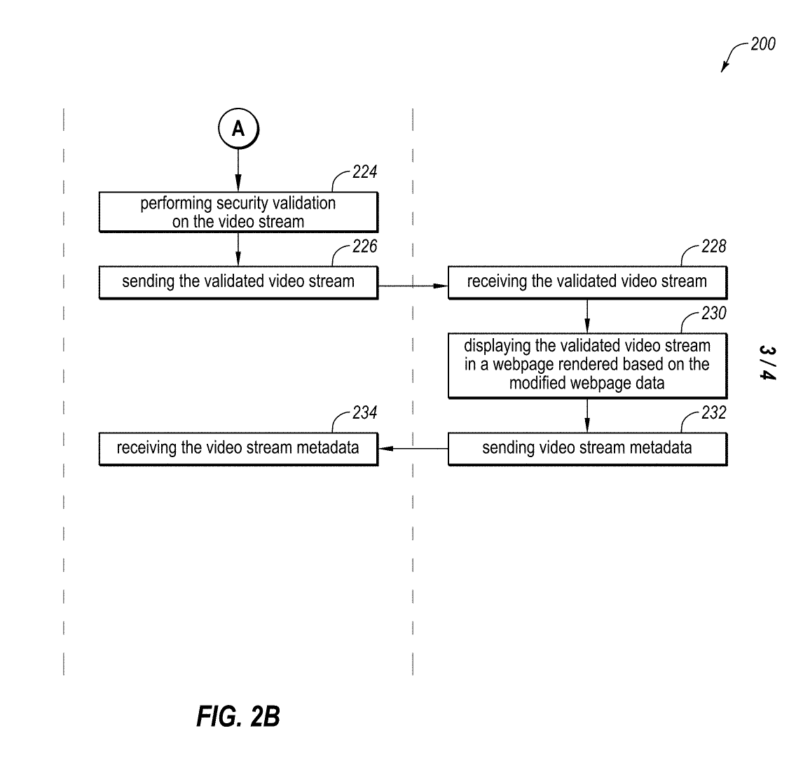

In some embodiments, the remote isolation server 106 may be employed by an organization that manages and/or protects the network 102 and/or the local network device 104, and/or any of the webservers 108a-108n. In some embodiments, the remote isolation server 106 may include a security application 116. The security application 116 may be configured to secure the local network device 104 from any malicious executable content found in a webpage, as disclosed in greater detail in connection with FIGS. 2A-2B herein. In some embodiments, the security application 116 may function as a remote isolation environment, where malicious executable content in a video stream can be safely handled by performing a security validation on the video stream to prevent the malicious executable content from executing on the browser 114, thus protecting the local network device 104 from ever being exposed to any such malicious executable content. In some embodiments, the security application 116 may function as a remote isolation system where execution of computer code on that system is separate and/or “isolated” from computer code that is executed on the local network device 104. Accordingly, for example, malware or viruses that exists in content of a webpage may be executed and “isolated” from the local network device 104 being operated by an end user. In some embodiments, the security application 116 may include, or may be associated with, additional components, such as a client isolation frontend 132, a browser engine 134, a rendering engine 136, an image compression engine 138, a Pepper plugin 140, and an FFMPEG package 142. In some embodiments, the browser engine 134 may be a WebKit or Blink browser engine. Each of these additional components will be discussed below in connection with FIG. 2.

In some embodiments, the remote isolation server 106, and the security application 116 and additional components thereon, may include, or be part of, a network security device or application such as Symantec Corporation's ProxySG S200/S400/S500 appliance or virtual appliance or cloud service, Symantec Corporation's Secure Web Gateway (SWG), Symantec Corporation's Secure Web Gateway Virtual Appliance (SWG VA), Symantec Corporation's Advanced Secure Gateway (ASG) S200/S400/S500, or Symantec Corporation's Web Isolation.

Modifications, additions, or omissions may be made to the system 100 without departing from the scope of the present disclosure. For example, in some embodiments, the system 100 may include additional components similar to the components illustrated in FIG. 1 that each may be configured similarly to the components illustrated in FIG. 1.

FIGS. 2A-2B are a flowchart of an example method 200 for remotely validating a webpage video stream. The method 200 may be performed, in some embodiments, by a device or system, such as by the webserver 108a, by the security application 116 on the remote isolation server 106, and by the browser 114 on the local network device. In these and other embodiments, the method 200 may be performed by one or more processors based on one or more computer-readable instructions stored on one or more non-transitory computer-readable media. The method 200 will now be described in connection with FIGS. 1 and 2A-2B.

In some embodiments, the actions of the method 200 may be performed in connection with the actions of a method 300 disclosed in U.S. patent application Ser. No. 15/935,600, filed Mar. 26, 2018, which is incorporated herein by reference in its entirety. While the method 300 disclosed in U.S. patent application Ser. No. 15/935,600 focuses primarily on webpage rendering using a remotely generated layout node tree, and thus focuses primarily on non-video stream webpage content, it is understood that the actions of the method 300 disclosed in U.S. patent application Ser. No. 15/935,600 may be employed in connection with the method 200 in order to handle both non-video stream webpage content as well as video stream webpage content.

In some embodiments, the initial action of the method 200 (e.g., action 202) may be performed in response to a browser, at a local network device, requesting access to a webserver. For example, a user may type a URL into the browser 114 on the local network device 104, such as “www.youtube.com.” This URL may correspond to the domain 118a and the webpage 120a hosted at the webserver 108a. In response to the user typing this URL into the browser 114, the browser 114 may send a request to the webserver 108a for the webpage 120a at the domain 118a. This request, or the response to this request from the webserver 108a, may then be intercepted by the security application 116 in order to securely prevent the webserver 108a from sending webpage data corresponding to the webpage 120a directly to the browser 114. This interception by the security application 116 may then result in the action 202.

The method 200 may include, at action 202, sending webpage data that includes a reference to a video stream and, at action 204, receiving the webpage data. In some embodiments, the webpage data received from the webserver at action 204 may include one or more of Hypertext Markup Language (HTML) data, Cascading Style Sheet (CSS) data, Fonts data, JavaScript data, Scalable Vector Graphics (SVG) data, Flash data, and data in any other browser rendering format. For example, the webserver 108a may send, at action 202, and the security application 116 may receive, at action 204, webpage data corresponding to the webpage 120a that is hosted at the domain 118a on the webserver 108a. The received webpage data may include, for example, HTML data, CSS data, Fonts data, JavaScript data, SVG data, Flash data, and data in any other browser rendering format. The webpage data may further include a reference to the video stream 121a.

The method 200 may include, at action 206, modifying the webpage data to change a source of the video stream in the reference from the webserver to the remote isolation server. In some embodiments, the reference received at action 204 may include a reference to a metadata file that contains video playing instructions for the video stream, and the modifying at action 206 may include changing the source of the video stream in the metadata file. In these embodiments, the metadata file may be a video manifest file. For example, the security application 116 may modify, at action 206, webpage data corresponding to the webpage 120a to change a source of the video stream 121a in a reference to the video stream 121a (such as in a manifest file corresponding to the video stream 121a) from the webserver 108a to the remote isolation server 106. In some embodiments, this modification may prevent the browser 114 from accessing the video stream 121a directly from the webserver 108a, but will instead force the browser 114 to access the video stream 121a through the security application 116.

In some embodiments, the modifying at action 206 may further include modifying the webpage data to change a document object model of the webpage data to substitute an alternative video player for an original video player due to the local browser not supporting the original video player. For example, the security application 116 may modify, at action 206, webpage data corresponding to the webpage 120a to change a document object model of the webpage data to substitute an alternative video player (such as an HTML5 player) for an original video player (such as a Flash player) due to the browser 114 not supporting the original video player.

It is understood that non-video stream content of the webpage data may also be modified at action 206, such as by performing the actions of the method 300 disclosed in U.S. patent application Ser. No. 15/935,600.

The method 200 may include, at action 208, sending the modified webpage data and, at action 210, receiving the modified webpage data. For example, the security application 116 may send, at action 208, and the browser 114 may receive, at action 210, the modified webpage data that includes the changed reference to the video stream 121a as well as changes to other parts of the webpage data (e.g., the DOM of the webpage data).

The method 200 may include, at action 212, sending a first request for the video stream and, at action 214, receiving the first request. For example, the browser 114 may send, at action 212, and the security application 116 may receive, at action 214, a first request for the video stream 121a. The first request may be based on the changed reference to the video stream 121a that the browser 114 received at action 210.

The method 200 may include, at action 216, sending a second request for the video stream and, at action 218, receiving the second request. For example, the security application 116 may send, at action 216, and the webserver 108a may receive, at action 218, a second request for the video stream 121a. The second request may be sent in response to receipt of the first request by the security application 116, and may be the same as the first request (e.g., the first request may be forwarded as the second request), or may be different from the first request (e.g., the second request may be newly-created).

The method 200 may include, at action 220, sending the video stream and, at action 222, receiving the video stream. For example, the webserver 108a may send, at action 220, and the security application 116 may receive, at action 222, the video stream 121a, which may include the malicious executable content 122a. In some embodiments, due to the video stream 121a being relatively large, the video stream 121a may be sent and received at action 220 and 222 in packets over a period of time, which may be a period of time that spans seconds, minutes, or even hours. Therefore, it is understood that the video stream 121a may be sent in stages (e.g., streamed) to the security application 116 over a period of time instead of being sent to the security application 116 all at once.

The method 200 may include, at action 224, performing security validation on the video stream. In some embodiments, the performing of the security validation at action 224 may be performed without rendering the video stream at a remote isolation server. In some embodiments, the performing of the security validation at action 224 may be performed without performing synchronization between video and audio at a remote isolation server. For example, the security application 116 may perform, at action 224, security validation on the video stream 121a that was received at action 222. This security validation may be performed by the security application 116 without rendering the video stream 121a at the remote isolation server 106, so that the only rendering (e.g. display) of the video stream 121a occurs at the local network device 104 in the browser 114, which may decrease the amount of processing and time required to perform action 224. This security action may additionally or alternatively be performed by the security application 116 without performing synchronization between video and audio at a remote isolation server, so that the only synchronization of the video and audio of the video stream 121a occurs at the local network device 104 in the browser 114, which may decrease the complexity of the security validation performed at action 224. As noted above, where the video stream 121a is streamed to the security application 116 in stages over a period of time, the performing of the security validation on the video stream 121a may also be performed in stages over a period of time.

In some embodiments, the performing of the security validation at action 224 may include transmuxing the video stream from an original video stream format to an alternative video stream format due to the local browser not supporting the original video stream format. In some embodiments, the performing of the security validation at action 224 may include transcoding the video stream to prevent an execution of malicious executable content in the video stream. For example, the security application 116 may transmux, at action 224, the video stream 121a from an original video stream format (e.g., a Flash format) to an alternative video stream format (e.g., an HTML5 format) due to the browser 114 not supporting the original video stream format. In another example, the security application 116 may transcode, at action 224, the video stream 121a to prevent an execution of the malicious executable content 122a in the video stream 121a.

The method 200 may include, at action 226, sending the validated video stream and, at action 228, receiving the validated video stream. In some embodiments, the sending at action 226 may include sending the validated video stream in a compressed video format. For example, the security application 116 may send, at action 226, and the browser 114 may receive, at action 228, the validated video stream 121a, such as in a compressed video format, which may keep the audio and video compressed together to avoid the security application 116 from having to synchronize the video and the audio. As noted above, where the video stream 121a is streamed to the security application 116 and validated by the security application 116 in stages over a period of time, the security application 116 may in turn send the validated video stream 121a to the browser 114 in stages over a period of time (e.g., may stream the validated video stream 121a).

The method 200 may include, at action 230, displaying the validated video stream in a webpage rendered based on the modified webpage data. For example, the browser 114 may display, at action 230, the validated video stream 121a in the webpage 120a that is rendered based on the modified webpage data that was received at action 210.

The method 200 may include, at action 232, sending video stream metadata and, at action 234, receiving the video stream metadata. In some embodiments, the metadata may include one or more of current display time in the video stream, an error indicating that a fallback process should be employed for the video stream, and a user interface event for the video stream. For example, the browser 114 may send, at action 232, and the security application 116 may receive, at action 234, metadata associated with the validated video stream 121a that is being displayed in the browser 114.

The method 200 may thus be employed, in some embodiments, to remotely validate the webpage video stream 121a to exclude content from the validated video stream 121a. By excluding all executable content from the video stream 121a of the webpage 120a, the method 200 may reliably exclude the malicious executable content 122a in the video stream 121a, and thus also reliably exclude the malicious executable content 122a from the subsequent display by the browser 114 of the version of the video stream 121a that underwent the security validation. In this manner, the method 200 may display a version of the video stream 121a in the webpage 120a at the local network device 104 without requiring the browser 114 to identify and sanitize the malicious executable content 122a in the video stream 121a, and without sending an unvalidated version of the video stream 121a to the local network device 104, thus securely preventing the malicious executable content 122a in the video stream 121a from being executed during the display of the video stream 121a in the webpage 120a in the browser 114 on the local network device 104.

Although the actions of the method 200 are illustrated in FIGS. 2A-2B as discrete actions, various actions may be divided into additional actions, combined into fewer actions, reordered, expanded, or eliminated, depending on the desired implementation. For example, in some embodiments, action 224 may be performed separately from the other actions of the method 200. Also, in some embodiments, actions 204-208, 214-216, and 222-226 may be performed separately from the other actions of the method 200.

Further, it is understood that the method 200 may improve the functioning of a computer system itself. For example, the functioning of local network device 104 and/or the remote isolation server 106 of FIG. 1 may itself be improved by the method 200. For example, the local network device 104 and/or the remote isolation server 106 may be improved by the method 200 remotely validating the webpage video stream 121a because this remote security validation may reliably exclude the malicious executable content 122a from the video stream 121a, and thus also reliably exclude the malicious executable content 122a from the subsequent display by the browser 114 of the validated video stream 121a, thus allowing the remote isolation server 106 to protect the local network device 104 from the malicious executable content 122a.

Also, the method 200 may improve the technical field of remote webpage browsing. For example, by the method 200 remotely validating a webpage video stream to reliably exclude any malicious executable content from the webpage video stream, and by doing so without requiring the browser to identify and sanitize malicious executable content in a video stream referenced in webpage data, the method 200 is an improvement over conventional methods of remote webpage browsing such as sanitization-based methods that are unacceptably unreliable.

The method 200 may be employed in an isolation computer system, such as the remote isolation server 106, to receive requests for webpages from endpoint browsers operated by users and pass on those requests to webservers to retrieve the requested webpage. The contents of the webpage may then be processed by the isolation computer system and the results of that processing may then be communicated to the endpoint browser for display to a user. In some embodiments, the content that is processed by the isolation computer system may be video content. The isolation computer system may process the video content based on the nature of the video content. In particular, the format of the video content and/or how that video content is sourced in the requested webpage may be used to determine how the video content should be processed. For example, a webpage may include a link to a manifest file (e.g., by an identifier). An isolation computer system may then modify the link within the webpage and the modified webpage may be delivered to an endpoint browser. The endpoint browser, as part of parsing the webpage, may then request the manifest file. The instructions for how a browser is to play video content may be provided in the manifest file. The isolation computer system may modify the manifest file in response to the request from the endpoint browser for the manifest file so that the links or pointers to the video content specified in the manifest file point to internal computing resources (e.g., a client isolation frontend executing on the isolation computer system). The modified manifest file may then be delivered to the endpoint browser, which then may begin playing a video specified by that file.

One challenge with implementing the method 200 may include delivering an end user experience that is similar or as close as possible to a native user experience—e.g., in terms of latency, bandwidth, and no modification of the applications used by the user (e.g., the same browser, no other software is required). While protocols such as RDP (remote desktop protocol), HDX (a protocol from Citrix), VNC (Virtual Network Computing), and RFB (Remote Frame Buffer) may attempt to address remote implementations, they may not provide sufficient user experiences that mimic a native browsing user experience (e.g., because of performance considerations, the need to install additional software, etc.). In some embodiments, visual feeds of remotely rendered webpages may be transferred to end user computer devices via an image rendering mode, via webpage Document Object Model (DOM) updates (or transfer of the entire DOM), via CSSDOM transfer, and/or via Render Tree updates. Some embodiments may use the techniques described in U.S. Patent Publication No. 2016/0352803 and/or U.S. Pat. No. 9,306,972, the entire contents of each of which are hereby incorporated by reference.

Client-Side Embodiments of the Method 200

In some embodiments of the method 200, a client-side video process may be implemented. In this mode, a video stream may be moved to the client side, and the client's computer (such as the browser 114 of the local network device 104) may be used to render the video. As the video is rendered on the client side (but not on an intermediary server, such as the remote isolation server 106), the intermediary server may gain processing savings (e.g., as the video stream is not being rendered on the intermediary server but is rather being passed through to the client side). Also, there may be no need to apply audio and video synchronization since both are streamed to the client. The browser on the client computer may handle the video and audio process (just as with standard web browser usage). The bandwidth requirements may also be decreased (e.g., in comparison to sending the video as a series of images with uncompressed audio). Specifically, the video may be sent from the intermediary server to a user computer system and the endpoint browser in a compressed video format. The video's data may be loaded only once and then sent directly to the client computer. This may allow for a drastic decrease in bandwidth consumption. This client-side embodiment of the method 200 will now be described.

In this client-side embodiment of the method 200, a user may spin up (e.g., execute) the browser 114 on their local network device 104 and browse (e.g., by typing in a URL to the address bar of a browser 114 or clicking on a link in an email message) to the webpage 120a that contains the video stream 121a. As a result of this action, a request may be sent from the local network device 104. Under normal circumstances this request would be transmitted directly to the webserver 108a. Here, however, the request may be intercepted by the remote isolation server 106, which is functioning as a remote isolation system. The request may be intercepted by using, for example, a forward proxy, a reverse proxy, a webpage acting as an isolation portal, a DNS server that would return the isolation server IP, a browser extension, or the like.

In some embodiments, the remote isolation server 106 may operate as an incoming email server. The email server may be programmed to rewrite links that are provided within the received emails to point to an isolation environment (e.g., the client isolation frontend 132 in the security application 116). Accordingly, for example, if a user receives an email with a link, that link may be rewritten to point to an internal link that is provided by an isolation environment of the remote isolation server 106. The isolation environment of the security application 116 may then retrieve the webpage 120a associated with the original link. The isolation environment of the security application 116 may store a database of transformed links and original links.

Next, the security application 116 may create an isolated container with an instance of the remote browser engine 134 inside. For example, the container may be a Linux Container (LXC), which is a system level virtualization OS-level technique that has access to its own memory space and network resources. This type of virtualization technique typically may have less overhead than running a full virtual machine. In some embodiments, the created browser engine 134 may be operated with the least privileged permissions, which may provide an added layer of security. The remote isolation server 106 may have a monitoring service that is programmed to monitor the behavior of the containers (and processes therein) along with CPU/memory usage. Thus, for example, if the monitoring service detects that a particular browser engine 134 is using too much (e.g., above a threshold value) processor time or too much memory, the browser engine 134 (or the container) may be terminated. The container and/or remote isolation server 106 may run a hardened operating system with a small attack surface. The small attack surface may be provided because the operating system is designed to handle browser instances in an isolated environment as described herein. This remote browser engine 134 may be executed by the remote isolation server 106 on behalf of the browser 114. The remote browser engine 134 on the remote isolation server 106 may then submit a web request to the webserver 108a. The request may be based on (or may be the same as) the initial request from the browser 114.

In this client-side embodiment of the method 200, the remote browser engine 134 may then, at actions 202 and 204, download the webpage 120a. This may include downloading any underlying resources for the webpage 120a (e.g., CSS, image files, JavaScript, video streams, etc.). Then, at action 206, the remote browser engine 134 may execute the webpage 120a, and the rendering engine 136 may extract any video streams, such as the video stream 121a, that are part of the webpage 120a and stop playing the video in the remote browser engine 134. This may prevent playing of the video within the browser engine 134 that is executing on the remote isolation server 106. The rendering engine 136 may then parse the HTML of the webpage 120a and render the webpage 120a. The rendering engine 136 may be a sandboxed process such that it is not allowed to initiate network requests or perform disk operations. This sandboxing approach for the rendering engine 136 may block or prevent, for example, JavaScript code contained in the webpage 120a from reading anything from disk since the entire rendering engine 136 process is sandboxed. On the other hand, the browser engine 134 may not be a sandboxed process and may handle all network requests or disk operations related to the webpage 120a. Thus, for example, if the rendering engine 136 requires something from disk or something over the network 102, it may send a request to the browser engine 134, which may then carry out the request on behalf of the rendering engine 136. In some embodiments, communication between the rendering engine 136 and the browser engine 134 may be handled through inter-process communication (IPC).

After actions 208 and 210, the browser 114 may be notified that it should play the extracted video stream 121a by an identifier that acts as a pointer to the video's source (e.g., the identifier having been previously generated by the rendering engine 136 and provided to the browser 114). The communication channel between the browser 114 and the remote isolation server 106 can be created, for example, using HTTP/S or websockets (this channel may also be used in communications discussed below).

Next, the browser 114, based on the notification and metadata received via the communication channel from the remote isolation server 106, may create a video player and position it in the correct location of the rendering of the webpage 120a. In some embodiments, the video player that is used by the browser 114 does not have to be the original video player specified in the originally requested webpage 120a. For example, an organization may use one video player that has been tested and verified for all video streams. The adoption of a single video player may thus shield end users from vulnerabilities in the video player used by a particular webpage. It will be appreciated that when the video player is created by the browser 114 that it may be created side-by-side with the HTML canvas that is used to render images of the originally requested webpage 120a. Techniques for such webpage rendering may be provided in the patent documents incorporated by reference in this application.

Once the video player is created within the browser 114, the browser 114 may send, at action 212, and the remote isolation server 106 may receive, at action 214, a request for the video stream 121a that is to be played within the created video player. The browser 114 may request the video stream 121a by using the identifier it received at action 210. This can be a request that is made by using, for example, HTTP/S.

The receipt, at action 214, of the request for the video stream 121a from the browser 114 may cause the remote isolation server 106 to fetch the actual video stream 121a from the webserver 108a at actions 216, 218, 220, and 222. Then, once the video stream 121a is received at action 222, the remote isolation server 106 may apply, at action 224, a security validation to the video stream 121a. For example, a TrueType validation can be applied, or any of the other validations disclosed herein. After the video stream 121a is validated at action 224, the validated video stream 121a may be transmitted to the browser 114, at actions 226 and 228, and the browser 114 may display, at action 230, the validated video stream 121a in the created video player. Then, at actions 232 and 234, the browser 114 may continue communicating with the browser engine 134 and rendering engine 136 on the remote isolation server 106 to exchange metadata such as: current time in video, errors for fallback, pause, stop events, etc.

Native Video Embodiments of the Method 200

In some embodiments of the method 200, a native video playing experience may be provided for end users. Many different video formats, video players, and video sources are available on the vast number of different webpages across the Internet. Furthermore, different APIs may be used to supply the source of the video by using HTML, JavaScript, or third party plugins such as Flash. In some embodiments, it may be beneficial if the remote isolation server 106 is able to extract the source of the video correctly. Correct extraction of the video may allow implementation of an end-to-end video streaming technique (e.g., client side) as suggested herein. The following are examples of how the video content on a webpage may be sourced differently—along with example implementations for addressing each of the different sourcing schemes.

A first example native video embodiment of the method 200 may involve a webpage that includes the source of a video as a native URL. For example, a webpage may include the following <video> element for a video that is displayed as part of a webpage:

<video width=“320” height=“240” autoplay>
<source src=“http://www.domain.com/videos/movie.mp4” type=“video/mp4”>
</video>

In this first example, the source of the video may be pulled directly from the supplied URL.

A second example native video embodiment of the method 200 may involve the video content being supplied as blob (e.g., binary large object) content. One example of blob content may be a link to, for example, a YouTube video where the source of the video is provided as: <video src=“blob:https://www.youtube.com/05c46198-e68a-44d6-8d76-fb4868f46efa”></video> When video content is included in the webpage in this manner, the source is actually a pointer to a buffer created in the browser engine 134. In some embodiments, a process may be implemented on the remote isolation server 106 to discover the metadata files of the blob. The metadata files may describe how videos can be played using, for example, a format like m3u8 (the m3u file format where the text is UTF-8) or Dynamic Adaptive Streaming over HTTP or DASH, etc. The remote isolation server 106 can then send the metadata files to the browser 114.

A hijacking or discovery process may take place using these techniques that may lead to a native video playing experience from an end user perspective. Also, while this example references HTTP live streaming (HLS) video content provided in association with an m3u8 formatted metadata file, the described process is also applicable to other video content formats and/or other metadata file formats (e.g., DASH and the like). This process may begin with an initial request from the browser 114 on the local network device 104. This request may be sent to the remote isolation server 106 (or the request may be intercepted by the remote isolation server 106), which may then submit the request to webserver 108a. Then, the techniques herein may allow for the parsing and/or modification of metadata files that contain video playing instructions. The metadata files are then delivered to the browser 114, and the browser 114 may render video therein (e.g., where the video source is now from the remote isolation server 106 as opposed to the original external source of the webserver 108a).

At actions 202 and 204, in response to the initial request from the browser 114, the webpage 120a is downloaded with its resources and those resources are processed, at action 206, by the remote browser engine 134 executing on the remote isolation server 106. The webpage 120a may include resources with reference to a video provided via M3U8 encoding (e.g., as set forth in the above example). The browser engine 134 that is executing the webpage contents may detect that a buffer will be created for the blob content. Specifically, off-the-shelf browsers may include a software method or function (e.g., “createBuffer( )” or similar function) that is used to create a buffer for blob content upon detection of a blob within a webpage. In some embodiments, the techniques herein may override this method call with a new (or modified) method call that is used to detect when blob content is contained within a webpage and subsequently save the location of the buffer (e.g., a pointer) and the video content (e.g., a reference to that content) that will be provided to that buffer. The browser engine 134 may then parse the m3U8 blob and create a data structure that maps the real video content to metadata chunks (e.g., a video manifest). In some embodiments, all of the requests (e.g., requests to the webserver 108a) initiated by the browser engine 134 may be observed. For those requests that relate to m3u8 files (or other relevant file type), the response(s) from the webserver 108a may be parsed to build the created data structure.

At actions 206, additional video content may be retrieved from the webserver 108a and stored into the created data structure. More specifically, the requests made from the browser engine 134 may be observed for video stream requests. When such a request is issued from the browser engine 134, then the responsive video content from the webserver 108a may be sent to the rendering engine 136 and the above noted data structure may be populated. In some embodiments, the data structure may be a tree or graph-like data structure with the root of the data structure holding the manifest file and the leaves holding binary content of the video content received from the webserver 108a. In some embodiments, the manifest file in the root node may point to other manifest files and/or to video chunks.

After actions 208 and 210, the browser 114 may create a video player at the correct size and location within the browser window (or elsewhere on another display). The size and location may be specified in accordance with the original HTML provided by the webpage 120a and may be provided to the browser 114 via DOM, CSSDOM, and/or render tree updates, for example. Then, once the URL (or other identifier) for the manifest file is received by the browser 114, the browser 114 may then request, at action 212, the manifest file from the client isolation frontend 132 executing on the remote isolation server 106. In response to the request received at action 214 from the browser 114, the remote isolation server 106 may fetch (or prepare to fetch), at actions 216-222, the real video stream 121a and the real manifest from the webserver 108a.

In some embodiments, security validations may be applied at action 224. In some embodiments, a security validation may include a TrueType validation. These validations may confirm that the correct type of file is being sent to the browser 114. Thus, for example, only video files and manifest files may be sent to the browser 114. If the webserver 108a sends, for example, an image in response to a request for video content, the image may not be sent to the browser 114. In some embodiments, a security validation may include a token validation. With these validations the remote isolation server 106 may verify that only it is creating links to the client isolation frontend 132 and that other actors are not able to create such internal links. In some embodiments, a security validation may include a content type validation. This may include verifying that the content requested is a video-related content type.

The manifest files fetched from the webserver 108a may contain links directly to an Internet address (e.g., myvideos.video.com or 191.185.1.1). Therefore, the client isolation frontend 132 running on the remote isolation server 106 may transform those links within the manifest file to point back to the client isolation frontend 132. Thus, the manifest file that was originally fetched from the webserver 108a and that contained a link to, for example, myvideos.video.com may be rewritten to point to, for example, clientisolation.internal.com. Then, once the client isolation frontend 132 has transformed the links within the manifest file, the transformed manifest file may be transmitted to the browser 114. In response to reception of one of the transmitted manifest files, the browser 114 may read the received manifest file and request, from the remote isolation server 106, the video content using the transformed links provided in the manifest file. The remote isolation server 106, via the client isolation frontend 132, may then pipe the real video content back to the browser 114. In some embodiments, the video content may be piped without modification or, alternatively, may be transformed, at action 224, prior to being sent along to the browser 114.

For example, at action 224, the retrieved video content may be transformed using one or more techniques as part of the rendering process being performed by the rendering engine 136. One example transformation may be transmuxing the video that is being processed by the remote isolation server 106. For example, video content retrieved from the webserver 108a may be in one video format type and may be transformed into a second, different, video format type before being transmitted to the browser 114 from the remote isolation server 106. In some embodiments, only some parts of the video may be transmuxed. In some embodiments, all or none of the video content may be transmuxed. The decision to transmux the original video content may be based on the type of the browser 114 (e.g., whether a Safari, IE 6, Edge, Chrome, etc.), the version or other installation status of plugins for the browser 114 (e.g., whether a Flash plugin is available), administrative factors (e.g., an organization may require transmuxing in all cases or only for certain users), and/or other computing environment factors (e.g., the type of operating system running on the local network device 104).

Further, at action 224, the browser engine 134 running on the remote isolation server 106 may be modified such that execution of commands that play the video stream 121a (e.g., by using the JavaScript AppendBuffer( ) method) may be detected. The standard behavior for such commands may be modified (or supplemented) so that the video content being appended (in the case of execution of the AppendBuffer( ) method) is matched against the binary values in the video data structure that has been created (e.g., matched against one of the leaves of the tree data structure). In some embodiments, the AppendBuffer( ) method may be left unchanged and unmodified. Instead, before (or after) the AppendBuffer( ) method is called, additional programmatic operations may be performed. For example, the matching process noted above may be run before the AppendBuffer( ) method is called. In other examples, the AppendBuffer( ) method may be overloaded. If a match is identified, then a URL (or other identifier) for the manifest file (or the manifest file itself) may be sent to the browser 114 running on the local network device 104.

At actions 232 and 234, the browser 114 may continue communicating with the browser engine 134 and/or the client isolation frontend 132 to exchange metadata such as, for example, the current time in the video being played, errors for fallback, and/or user interface events (e.g., pause, stop, rewind, fast forward, etc.).

In some embodiments, the video process may have a fallback process for webpages or video content that uses an uncommon and/or proprietary video player system. In some embodiments, the remote isolation server 106 may execute a browser engine instance of a type of browser that does not support blob content. For example, some versions of Microsoft's Internet Explorer browser (e.g., IE 6.0) do not support opening blob content within a browser. In some embodiments, a browser engine 134 instance may be modified so the webserver 108a believes the request is coming from a browser engine 134 instance that does not support blobs. This may be accomplished by modifying the user-agent header of the original request from the remote isolation server 106. Because some browsers do not support blobs, some webpages may have a fallback that supplies a native URL to the video content, as described herein. An example implementation may include leveraging an on-premise library, such as youtube-dl, or a cloud service that is able to extract the original video stream from a given video. It will be appreciated that there may be some complexities with this approach. In order to load the webpage 120a using the browser engine 134 (e.g., Internet Explorer), the specific URL in which the video appears may still have to be extracted. As an example, a webpage at a general URL such as https://www.facebook.com may play a different video every time the user refreshes the webpage. A cloud service may abstract several mechanisms and data sources that know how to extract the original video source from a given URL, one example would be the youtube-dl program that allows users to download videos from YouTube. If a cloud service is used it may have the advantage of allowing a central update to the logic to reach all of the servers (e.g., the remote isolation server 106) that make use of this functionality.

Black-Box Video Embodiments of the Method 200

In some embodiments of the method 200, certain types of videos may be provided in so-called black-box implementations. Such implementations may provide full stack programming and an execution environment that may embed and/or implement many different video players and formats (e.g. FLV, F4V, m3u8, etc.). The Flash plugin from Adobe is one example of a black-box implementation. With these types of implementations, the systems may not be able to rely on the existence of an API that will extract the video source. One example of the HTML used to include a black-box implementation (taken from flowplayer.org) is as follows:

```
<object class=“fp-engine” id=“obj5301211494484” name,“ obj5301211494484”
data=“//releases.flowplayer.org/7.0.4/flowplayer.swf”   type=“application/x-
shockwave-flash”>
  <param name=“width” value=“100%”>
  <param name=“height” value=“100%”>
  <param name=“allowscriptaccess” value=“always”>
  <param name=“wmode” value=“opaque”>
  <param name=“quality” value=“high”>
  <param name=“flashvars” value=“hostname=demos.flowplayer.org&url=http://
  edge.flowplayer.org/flowplayer-700.flv&callback=fpCallback239779693883&
  proxy=best&live=false&debug=false&splash=false&hlsQualities=true&initialVol
  ume=1&”>
  <param name=“movie” value=“//releases.flowplayer.org/7.0.4/flowplayer.swf ”>
  <param name=“name” value,” obj5301211494484”>
  <param name=“bgcolor” value=“#333333”>
</object>
```

When such video content is encountered there may not be a provided API that can be used to extract the video source. Further, since the video source does not exist within the DOM of the webpage, the techniques described herein may be used to find the real source of the video that is being played.

In some embodiments, an observer routine (which may be a sub-routine within another process, such as the rendering engine 136 process, or its own process), may be created to parse inter-process communication (IPC) messages that are passed between the rendering engine 136 on the remote isolation server 106 and the black-box that is used to process the video content. For example, if the video content is provided via Adobe Flash, then the Pepper (Flash) plugin 140 from Google may be used as a program for carrying out the processing required to process the video content in the Flash part of a webpage 120a. Although the example discussed below is provided in the context of the Pepper plugin 140, it will be appreciated that other types of processes, plugins, or programs may be used with the techniques discussed herein.

Since the Pepper plugin 140 process is sandboxed, it may not be able to retrieve the video data by itself. Instead, this sandboxed process may ask the rendering engine 136 to fetch the video data and send it to the sandboxed process. This request for the video content may be detected by, for example, the above noted observer process. When the request is detected, the DOM of the webpage 120a that contains the video stream 121a may be modified so as to add an HTML5 video with the video source's identification. The video content may then be sent to the client as explained herein.

The browser 114 may use one of the following in order to play the video: 1) If the video's format is supported natively by the browser 114, then the browser 114 may play the video; 2) If the video's format is not supported natively by the browser 114, then an external video player (e.g., a proprietary Flash player) may be used in order to play the video. In some embodiments, the local network device 104 may need to have the Flash enabled in order to play those kind of videos correctly.

In some embodiments, since the remote isolation server 106 may not be able to pause or stop the Flash process (e.g., in the isolated rendering engine 136), a different mechanism may be used so the Flash process does not play the video. In some embodiments, the real response from the webserver 108a (with the real video content) may never be sent to the sandboxed Flash process (e.g., the Pepper plugin 140 process via IPC). Instead, the rendering engine 136 may send updates to the Flash process that the video content is still being downloaded (e.g., a download update may be sent every few milliseconds). Accordingly, the Flash process may not play anything since it does not even have the video content. Correspondingly, once the client is finished playing the video, an empty video may be served to the Flash player that is specified in the webpage 120a, which then plays the video. But since the video is empty, the video finishes.

In some embodiments, a Flash video may be played and the video content may be provided to the browser 114. This may be accomplished using communication that occurs between the rendering engine 136 and the Pepper plugin 140. In particular, a request (that is based on an initial request from the browser 114) may be sent from the remote isolation server 106 to the webserver 108a. As part of this request, the webserver 108a may deliver, to the remote isolation server 106 and the browser engine 134 that made the request, the resources for the webpage 120a, including the Flash object that plays the video. Then, as part of the processing of the retrieved webpage 120a (e.g., by parsing or building the DOM), the rendering engine 136 may then detect the presence of a Flash object within the contents of the webpage 120a. The rendering engine 136 may then submit a request to the Pepper plugin 140 to initialize and run a sandboxed Flash process. Next, messages from the Pepper plugin 140 to the rendering engine 136 may be intercepted. For example, all messages related to Internet browsing or navigation communicated by the Pepper plugin 140 to the rendering engine 136 may be intercepted. Those messages that relate to video requests may be detected at this point. As noted above, the Pepper plugin 140 may be a sandboxed process. The sandboxing may occur using Google Chrome's plugin architecture, where each plugin is its own process that communicates with the rendering engine 136 via IPC. Such techniques are detailed at www.chromium.org. Using such an architecture may prevent the plugins from communicating directly with the Internet or other external sources. Instead, the plugin may communicate through the rendering engine 136. This type of implementation may thus provide additional security benefits in some embodiments. Next, based on interception of the relevant messages from the Pepper plugin 140 (e.g., those related to video requests), the rendering engine 136 may construct customized messages that are sent to the Pepper plugin 140 in response. These messages may be tailored to both prevent the Pepper plugin 140 from crashing and from playing a video. An example of such messages may include, for example, messages that the video content is still downloading. While the customized messages are generated and sent to the Pepper plugin 140, the DOM of the originally requested webpage 120a may be modified to create an HTML5 video player alongside the original Flash Player (the HTML5 player may also have been created earlier). In some embodiments, other types of video players may be used instead of HTML5. The HTML5 player may be created with the same dimensions and other properties of the Flash player. This modified DOM may then be executed within the rendering engine 136 and/or the browser engine 134 on the remote isolation server 106. In some embodiments, the original Flash object within the DOM that is executed on the remote isolation server 106 may not be replaced, but rather the above noted HTML5 video player may be added to the DOM. A potential benefit to this approach is that any JavaScript or other references to the Flash object that exist within the webpage 120a may be maintained. Accordingly, when the rendering engine 136 and/or browser engine 134 on the remote isolation server 106 parses and/or executes the webpage 120a, it may execute both the HTML video player and the original Flash object (e.g., by using the Pepper plugin 140). Next, the created HTML5 video (and webpage) may be transmitted to the browser 114 which plays the video. From a user perspective, the difference between the original webpage 120a retrieved from the webserver 108a and the modified webpage 120a that is actually delivered to the browser 114 may be indistinguishable to the user. In some embodiments, other parts of the webpage 120a may have been transmitted to the browser 114 already. In some embodiments, the DOM of the webpage 120a that is delivered to the browser 114 from the remote isolation server 106 may be further modified to remove the Flash object from the DOM, leaving the HTML5 video as the video source (which may have a reference back to the client isolation frontend 132 for the video content). In some embodiments, as discussed below, images may be sent to the browser 114. Accordingly, in this type of implementation, the original Flash object may not be sent to the browser 114. Next, the browser 114 may communicate a video-finish message to the remote isolation server 106 (e.g., to the rendering engine 136). In response to this message, the Pepper plugin 140 may be sent a video that is empty, which causes it to terminate.

As noted above, maintaining the Flash object in the webpage 120a being executed on the remote isolation server 106 may allow other aspects of the webpage 120a to continue to operate (e.g., if they reference the Flash object). In some embodiments, the empty video noted above may be presented to the Pepper plugin 140 so that any custom video-end-flow processes may be run. For example, a recommendation for similar videos may be shown. If a video were not supplied to the Pepper plugin 140 (e.g., if the Pepper plugin 140 process were just terminated), it could prevent this aspect of the original webpage 120a from operating correctly. The rendering engine 136 and/or the browser engine 134 may supply this video to the Pepper plugin 140 at a timing that corresponds to when the browser 114 finishes playing the video.

Transcoded Video Embodiments of the Method 200

In some embodiments of the method 200, videos may be transcoded and provided to the local network device 104. Transcoding a video stream (or more precisely re-transcoding an existing video stream acquired from a remote source—e.g., over the Internet) may add an additional layer of security since the original video is not being sent from the Internet source to the browser 114. Instead, the video may go through another modification and may be transcoded. This may alter the frames in the compression process and may remove bytes (e.g., specially crafted bytes) from the video stream. For example, the video stream 121a may have bytes (e.g., that when executed are the malicious executable content 122a) embedded in the video stream 121a that are designed to, for example, overrun a buffer or the like and thus begin executing the malicious executable content 122a. By transcoding the video stream 121a, the bytes that theoretically correspond to the malicious executable content 122a may be changed, thus preventing their execution. In some embodiments, the browser 114 may not have support for a particular video type (e.g., Flash video). If the browser engine 134 plays a Flash video which is not supported by the browser 114 (as discussed elsewhere herein), then the remote isolation server 106 may try to create its own player to in order to play this video. If the local network device 104 does not have Flash enabled, it may fail to create the player. Accordingly, in some embodiments, real-time video transcoding to a different format may be provided. This new format may be one (unlike the original) that is supported by the browser 114. In some embodiments, performance of the actual transcoding may be handled by a software package or library such as, for example, fast forward MPEG (FFMPEG) package 142, which may be a software package that handles multimedia data.

By using this, or other techniques, the original video may be transcoded to a format which is supported by the browser 114. Note that this might be a moving target since browsers can be frequently upgraded to add or remove capabilities and support. As an example, the following represents appropriate video formats for certain browsers as of early 2017. If the client uses Internet Explorer, then video transcoded to MP4 may be used. If the client uses Chrome, then video may be transcoded to WEBM. If the client uses Firefox, then the video may be transcoded to OGG.

In some embodiments, the transcoding process may be performed on the remote isolation server 106. In other examples, the transcoding process may be passed off to a dedicated server that may have GPU (which may boost the transcoding speed). In some embodiments, a cloud-based solution may be used. In order to play the transcoded video and provide an optimal user experience (e.g., to support seeks, pauses, and other user commands, for example), a custom video player may be used that supports all or a large number of the mentioned formats.

In some embodiments, a request for the webpage 120a may be submitted from the browser 114 running on the local network device 104. The remote isolation server 106 may respond by spinning up an instance of the rendering engine 136 and/or an instance of the browser engine 134. The remote isolation server 106 may then respond to the browser 114 with client-side isolation logic. In some embodiments, the client-side isolation logic may be provided when a client wants to browse external web resources in an isolated manner. The client-side isolation logic may be an HTML application that contains code and/or scripts (e.g., JavaScript) for communicating with the remote isolation server 106. Next, the browser 114 (in conjunction with the provided logic) may determine that Flash (or other video format) is not supported by the browser 114. This may be communicated to the remote isolation server 106. Next, upon determining that the browser 114 does not support Flash (or other video format), the rendering engine 136 running on the remote isolation server 106 may alter the video source for the video stream 121a in the requested webpage 120a to point to the FFMPEG package 142, or to another server that is executing an FFMPEG package. Then, the updated video source pointer may be provided to the browser 114. Next, the browser 114 may request the new video source. Then, the client isolation frontend 132 may receive the request and communicate with the FFMPEG package 142. The FFMPEG package 142 may transcode the real video stream and continuously pipe the transcoded video stream to the client isolation frontend 132, which may then pipe the transcoded stream to the local network device 104. This may occur as the FFMPEG package 142 requests the video from the Internet source. In some embodiments, TrueType, token, and/or content type validations may also be performed on the incoming real video stream 121a. The new, transcoded, video stream may then be received by the browser 114, which may then play the transcoded video stream.

It will be appreciated that some optimizations may be made to the FFMPEG package 142 to control the transcoding speed, quality, as well as other flags. In some embodiments (e.g., in an enterprise environment), the FFMPEG package 142 may be rolled into a rule-based policy engine and configured by an administrator.

Server-Side Embodiments of the Method 200

In some embodiments of the method 200, a server side mode implementation of the method 200 may provide video content to end user devices. This may be a simpler solution and may be used as a fallback mechanism for when client-side videos fail to execute for any reason. This technique may work as follows. A user may spin up the browser 114 on their local network device 104 and then browse to the webpage 120a that contains the video stream 121a. Next, the remote isolation server 106 may intercept the browsing request (via any of the different options described above using, for example, a proxy, a portal or a DNS) and may return an HTML5 client environment to the browser 114. Correspondingly, the remote isolation server 106 may create an isolated container with an instance of the browser engine 134 that would do the actual browsing to the webpage 120a on behalf of the user. The remote browser engine 134 may then download and execute the webpage 120a and the video stream 121a may play on the remote isolation server 106. During this process, the rendering engine 136 may capture images (e.g. in the form of an RGBA matrix) that should be drawn to a display. In some embodiments, the image compression engine 138 may extract the video rectangle part out of the RGBA matrix, compress the RGBA matrix into an image format (e.g. JPG or PNG) and send it to the browser 114. In addition, a command channel may be used to send audio from the remote isolation server 106 to the local network device 104 as well as metadata events such as screen resize from the local network device 104 to the remote isolation server 106. Since the browser 114 is running an HTML5 environment that was served from the remote isolation server 106, that environment may synchronize the images and the audio and may play the video as a series of images with audio in the browser 114. While this approach may involve scalability issues, user experience issues, and bandwidth issues, this approach may nevertheless be used as a backup when any of the other solutions disclosed herein fail.

FIG. 3 illustrates an example computer system 300 that may be employed in remotely validating a webpage video stream. In some embodiments, the computer system 300 may be part of any of the systems or devices described in this disclosure. For example, the computer system 300 may be part of any of the local network device 104, the remote isolation server 106, and the webservers 108a-108n of FIG. 1.

The computer system 300 may include a processor 302, a memory 304, a file system 306, a communication unit 308, an operating system 310, a user interface 312, and a module 314, which all may be communicatively coupled. In some embodiments, the computer system may be, for example, a desktop computer, a client computer, a server computer, a mobile phone, a laptop computer, a smartphone, a smartwatch, a tablet computer, a portable music player, a network device, a network security appliance, or any other computer system.

Generally, the processor 302 may include any suitable special-purpose or general-purpose computer, computing entity, or processing device including various computer hardware or software modules and may be configured to execute instructions stored on any applicable computer-readable storage media. For example, the processor 302 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 302 may interpret and/or execute program instructions and/or process data stored in the memory 304 and/or the file system 306. In some embodiments, the processor 302 may fetch program instructions from the file system 306 and load the program instructions into the memory 304. After the program instructions are loaded into the memory 304, the processor 302 may execute the program instructions. In some embodiments, the instructions may include the processor 302 performing one or more of the actions of the method 200 of FIGS. 2A and 2B.

The memory 304 and the file system 306 may include computer-readable storage media for carrying or having stored thereon computer-executable instructions or data structures. Such computer-readable storage media may be any available non-transitory media that may be accessed by a general-purpose or special-purpose computer, such as the processor 302. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 302 to perform a certain operation or group of operations, such as one or more of the actions of the method 200 of FIGS. 2A and 2B. These computer-executable instructions may be included, for example, in the operating system 310, in one or more applications, such as the browser 114 or the security application 116 of FIG. 1, or in some combination thereof.

The communication unit 308 may include any component, device, system, or combination thereof configured to transmit or receive information over a network, such as the network 102 of FIG. 1. In some embodiments, the communication unit 308 may communicate with other devices at other locations, the same location, or even other components within the same system. For example, the communication unit 308 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 308 may permit data to be exchanged with a network and/or any other devices or systems, such as those described in the present disclosure.

The operating system 310 may be configured to manage hardware and software resources of the computer system 300 and configured to provide common services for the computer system 300.

The user interface 312 may include any device configured to allow a user to interface with the computer system 300. For example, the user interface 312 may include a display, such as an LCD, LED, or other display, that is configured to present video, text, application user interfaces, and other data as directed by the processor 302. The user interface 312 may further include a mouse, a track pad, a keyboard, a touchscreen, volume controls, other buttons, a speaker, a microphone, a camera, any peripheral device, or other input or output device. The user interface 312 may receive input from a user and provide the input to the processor 302. Similarly, the user interface 312 may present output to a user.

The module 314 may be one or more computer-readable instructions stored on one or more non-transitory computer-readable media, such as the memory 304 or the file system 306, that, when executed by the processor 302, is configured to perform one or more of the actions of the method 200 of FIGS. 2A and 2B. In some embodiments, the module 314 may be part of the operating system 310 or may be part of an application of the computer system 300, or may be some combination thereof. In some embodiments, the module 314 may function as any one of the browser 114 and the security application 116 of FIG. 1.

Modifications, additions, or omissions may be made to the computer system 300 without departing from the scope of the present disclosure. For example, although each is illustrated as a single component in FIG. 3, any of the components 302-314 of the computer system 300 may include multiple similar components that function collectively and are communicatively coupled. Further, although illustrated as a single computer system, it is understood that the computer system 300 may include multiple physical or virtual computer systems that are networked together, such as in a cloud computing environment, a multitenancy environment, or a virtualization environment.

As indicated above, the embodiments described herein may include the use of a special purpose or general purpose computer (e.g., the processor 302 of FIG. 3) including various computer hardware or software modules, as discussed in greater detail below. Further, as indicated above, embodiments described herein may be implemented using computer-readable media (e.g., the memory 304 or file system 306 of FIG. 3) for carrying or having computer-executable instructions or data structures stored thereon.

In some embodiments, the different components and modules described herein may be implemented as objects or processes that execute on a computing system (e.g., as separate threads). While some of the methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A computer-implemented method for remotely validating a webpage video stream, at least a portion of the method being performed by a remote isolation server comprising one or more processors, the method comprising:
(a) receiving, at a remote isolation server, webpage data that includes a reference to a video stream from a webserver;
(b) modifying, at the remote isolation server, the webpage data to change a source of the video stream in the reference from the webserver to the remote isolation server;
(c) sending, from the remote isolation server, the modified webpage data to a local browser on a local network device;
(d) receiving, at the remote isolation server, a first request for the video stream from the local browser;
(e) sending, from the remote isolation server, a second request for the video stream to the web server;
(f) receiving, at the remote isolation server, the video stream from the webserver;
(g) performing, at the remote isolation server, security validation on the video stream; and
(h) sending, from the remote isolation server to the local browser, the validated video stream for display in the local browser in a webpage rendered based on the modified webpage data.

2. The method of claim 1, wherein the performing of the security validation at (g) is performed without rendering the video stream at a remote isolation server.

3. The method of claim 1, wherein the performing of the security validation at (g) is performed without performing synchronization between video and audio at a remote isolation server.

4. The method of claim 1, wherein the sending at (h) comprises sending the validated video stream in a compressed video format.

5. The method of claim 1, wherein:
the reference received at (a) comprises a reference to a metadata file that contains video playing instructions for the video stream; and
the modifying at (b) comprises changing the source of the video stream in the metadata file.

6. The method of claim 5, wherein the metadata file is a video manifest file.

7. The method of claim 1, further comprising:
(i) receiving, at the remote isolation server, metadata from the local browser, the metadata comprising one or more of current display time in the video stream, an error indicating that a fallback process should be employed for the video stream, and a user interface event for the video stream.

8. The method of claim 1, wherein:
the modifying at (b) comprises modifying the webpage data to change a document object model of the webpage data to substitute an alternative video player for an original video player due to the local browser not supporting the original video player.

9. The method of claim 1, wherein:
the performing of the security validation at (g) comprises transmuxing the video stream from an original video stream format to an alternative video stream format due to the local browser not supporting the original video stream format.

10. The method of claim 1, wherein:
the performing of the security validation at (g) comprises transcoding the video stream to prevent an execution of malicious executable content in the video stream.

11. One or more non-transitory computer-readable media comprising one or more computer-readable instructions that, when executed by one or more processors of a remote isolation server, cause the remote isolation server to perform a method for remotely validating a webpage video stream, the method comprising:
(a) receiving, at a remote isolation server, webpage data that includes a reference to a video stream from a webserver;
(b) modifying, at the remote isolation server, the webpage data to change a source of the video stream in the reference from the webserver to the remote isolation server;
(c) sending, from the remote isolation server, the modified webpage data to a local browser on a local network device;
(d) receiving, at the remote isolation server, a first request for the video stream from the local browser;
(e) sending, from the remote isolation server, a second request for the video stream to the web server;
(f) receiving, at the remote isolation server, the video stream from the webserver;
(g) performing, at the remote isolation server, security validation on the video stream; and
(h) sending, from the remote isolation server to the local browser, the validated video stream for display in the local browser in a webpage rendered based on the modified webpage data.

12. The one or more non-transitory computer-readable media of claim 11, wherein the performing of the security validation at (g) is performed without rendering the video stream at a remote isolation server.

13. The one or more non-transitory computer-readable media of claim 11, wherein the performing of the security validation at (g) is performed without performing synchronization between video and audio at a remote isolation server.

14. The one or more non-transitory computer-readable media of claim 11, wherein the sending at (h) comprises sending the validated video stream in a compressed video format.

15. The one or more non-transitory computer-readable media of claim 11, wherein:
the reference received at (a) comprises a reference to a metadata file that contains video playing instructions for the video stream; and
the modifying at (b) comprises changing the source of the video stream in the metadata file.

16. The one or more non-transitory computer-readable media of claim 15, wherein the metadata file is a video manifest file.

17. The one or more non-transitory computer-readable media of claim 11, wherein the method further comprises:
(i) receiving, at the remote isolation server, metadata from the local browser, the metadata comprising one or more of current display time in the video stream, an error indicating that a fallback process should be employed for the video stream, and a user interface event for the video stream.

18. The one or more non-transitory computer-readable media of claim 11, wherein:
the modifying at (b) comprises modifying the webpage data to change a document object model of the webpage data to substitute an alternative video player for an original video player due to the local browser not supporting the original video player.

19. The one or more non-transitory computer-readable media of claim 11, wherein:
the performing of the security validation at (g) comprises transmuxing the video stream from an original video stream format to an alternative video stream format due to the local browser not supporting the original video stream format.

20. The one or more non-transitory computer-readable media of claim 11, wherein:
the performing of the security validation at (g) comprises transcoding the video stream to prevent an execution of malicious executable content in the video stream.
